(19) United States
(12) Patent Application Publication
(10) Pub. No.: US 2005/0022500 A1
(43) Pub. Date: Feb. 3, 2005

(54) Rocket engine passivation system

(76) Inventor: David Benjamin Buehler, Provo, UT (US)

Correspondence Address: David Buehler, 893 West 2150 North, Provo, UT, 84604, US

(21) Appl. No.: 10/901,537

(22) Filed: Jul. 28, 2004

Related U.S. Application Data
(60) Provisional application No. 60/490,974, filed on Jul. 28, 2003.

(51) Int. Cl. F02K 1/00

(52) U.S. Cl. 60/223

(57) ABSTRACT

A system for protecting a rocket engine, comprising, a storage reservoir of first protectant material, a control system configured to release it after the engine has finished firing, a conduit to deliver first protectant material to the engine injector, a valve to isolate first protectant material storage reservoir, an apparatus configured to drive the first protectant material from the reservoir to the engine injector.

This application is a continuation of provisional application No. 60/490,974 filed on Jul. 28, 2003, titled “System for protecting liquid propellant rocket engine during ocean recovery”.

### BACKGROUND OF THE INVENTION

The invention is directed to space vehicles and more particularly to the recovering of the liquid propellant engines from space vehicles for reuse after landing in the ocean. This invention relates to an improvement in protection at a low cost for liquid propellant rocket engines.

### DESCRIPTION OF RELATED ART

Presently, the rocket stage and engine are not recovered at sea, in part because of the difficulty in ensuring that the engine is not damaged by exposure to seawater. Ocean recovery is desirable because it provides a large recovery area and cushions the rocket stage's landing.

Prior art systems designed to protect engines from seawater have involved mechanical means to erect a protective structure around the engine. One example of this type is found in patent the U.S. Pat. No. 4,830,314.

U.S. Pat. No. 5,328,132 discloses a folded, inflatable skirt which seals the aft portion of the rocket to protect the engine from moisture.

U.S. Pat. No. 4,961,550 discloses an extendable sleeve which is issued from the body of the rocket, extends beyond the engines, and seals itself to protect the engine from moisture.

U.S. Pat. No. 4,830,314 discloses a partial-spherical body in which the rocket engine is mounted, with an aperture from which the engine thrust is released. Following rocket launch, the sphere is detached from the rocket and panels are transposed to complete the sphere and seal it from moisture.

U.S. Pat. No. 5,083,728 discloses an inflatable plug which is transposed into the mouth of the rocket nozzle to protect the engine from moisture.

These methods are complex, which can increase the cost of design and manufacturing and may not be as reliable as less complex methods. The weight of the rocket is also increased with such methods, thus decreasing the possible payload size. Furthermore, the cost of the rocket is increased because of the needed resources to prepare and test these complex mechanisms before launch. What is needed is a less complex and costly method for protecting the rocket engine from seawater exposure. Cost savings could be obtained by protecting the rocket engines after use thus enabling low cost reuse on subsequent flights.

### BRIEF SUMMARY OF INVENTION

The principle object of this invention is to provide an economical, reliable method by which liquid fueled rocket engines can be reliably reused following ocean recovery.

The invention comprises the use of protectant material to protect a liquid-fuel rocket engine upon descent into the ocean. The protectant material is storied in a reservoir in the aft portion of the rocket. At some time after the engine shuts down and before the stage splashes into the ocean, a valve is opened and the first protectant material is caused to flow out into the fuel and oxidizer injector lines, through the injectors, into the combustion chamber.

The protectant material protects the engine from exposure to seawater by preventing the water from reaching the engines.

### BRIEF DESCRIPTION OF THE DRAWINGS

FIG. 1 is a perspective view of the launch sequence of a booster rocket for placing a payload in orbit and the return of the main stage engine to earth by parachute.

FIG. 2 is a side view of the main stage engine, illustrated floating in ocean water.

FIG. 3 is a schematic drawing showing the position of the fuel tank, oxidizer tank, main valve, first protectant material reservoir.

FIG. 4 is a cut-away illustration of the engine with the first protectant material deployed.

FIG. 5 is an enlarged schematic drawing of the lower end of the rocket, showing the cooling system, first protectant material reservoir, rocket engine, and valves.

FIG. 6 is the same as FIG. 5 but further comprising a second protective material reservoir.

### DETAILED DESCRIPTION

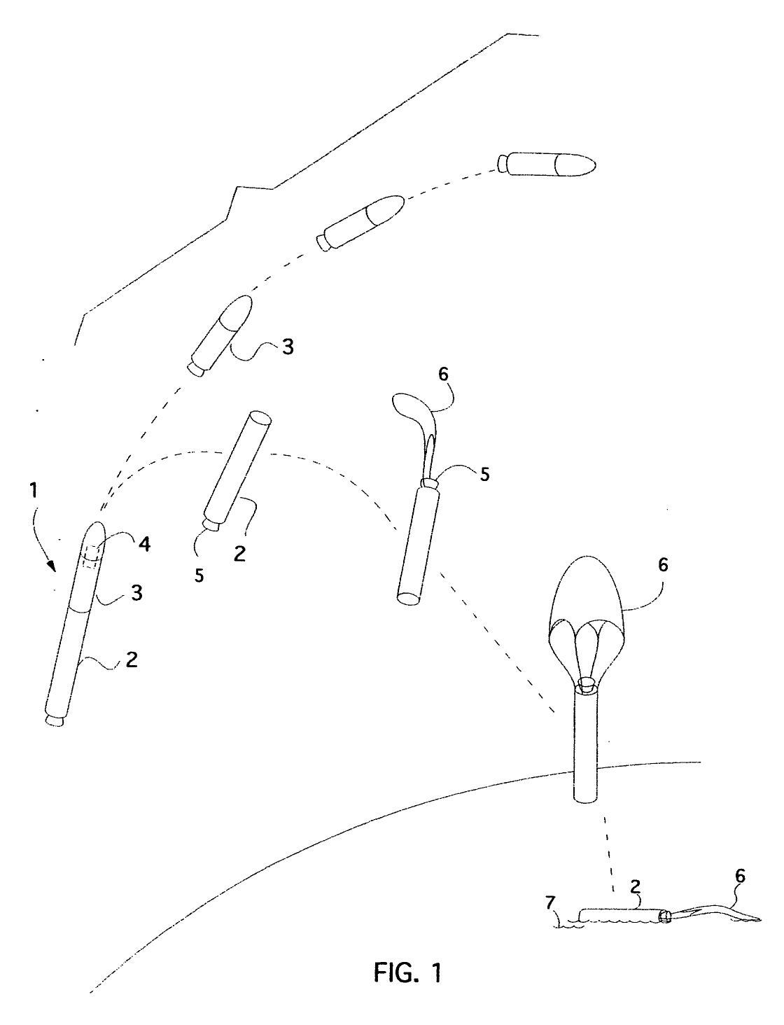

Referring to FIG. 1 the typical launch vehicle, indicated by numeral 1, includes a lower stage 2 and an upper stage 3. Typically two or more stages are necessary to place a satellite in orbit. The payload 4 is contained within the upper stage. The parachute 6 is connected to the aft part of the stage where the engine 5 is located. The rocket engine's landing site is the ocean 7. This invention could be applied to any rocket stage recovered in the ocean, a lower stage or an upper stage.

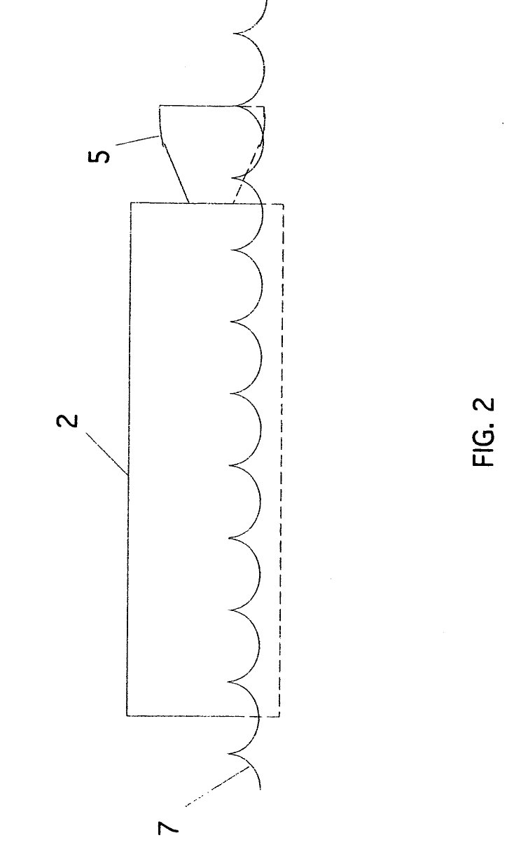

Referring to FIG. 2 the engine 5 and rocket stage 2 are shown partly submerged in the ocean water 7. The invention is particularly well suited for pressure-fed rocket engines, since there is no complex turbopumps which would need to be protected from sea water exposure. It is also well suited for stages with engines that don't gimbal, since it is easier to seal the outside of the engine nozzle to the tail of the rocket, and prevent any water from reaching the area around the the engines, ensuring that the plumbing, valves, and other mechanisms would not be reached by the water.

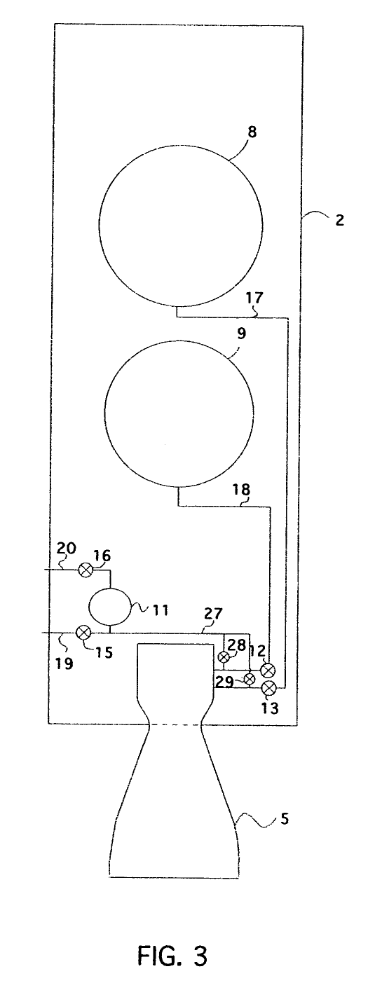

Referring to FIG. 3, an overall schematic drawing of a fuel propellant rocket stage 2 is shown, comprising of a fuel tank 9, an oxidizer tank 8, an engine 5, and a first protectant material reservoir 11. The oxidizer tank and fuel tank are connected to inlets 17 and 18 which route fuel and oxidizer to the engine through the main valves 12 and 13.

The first protectant material reservoir connects to tube 27 which separates into two tubes to connect with the fuel inlets 17 and 18 between the engine and valves 12 and 13. Two valves 28 and 29 are located between where tube 27 separate and where those two tubes connect to inlets 17 and 18. Tube 27 also joins with inlet 19, between which is valve 15. Reservoir 11 connects with valve 16 which connects to inlet 20.

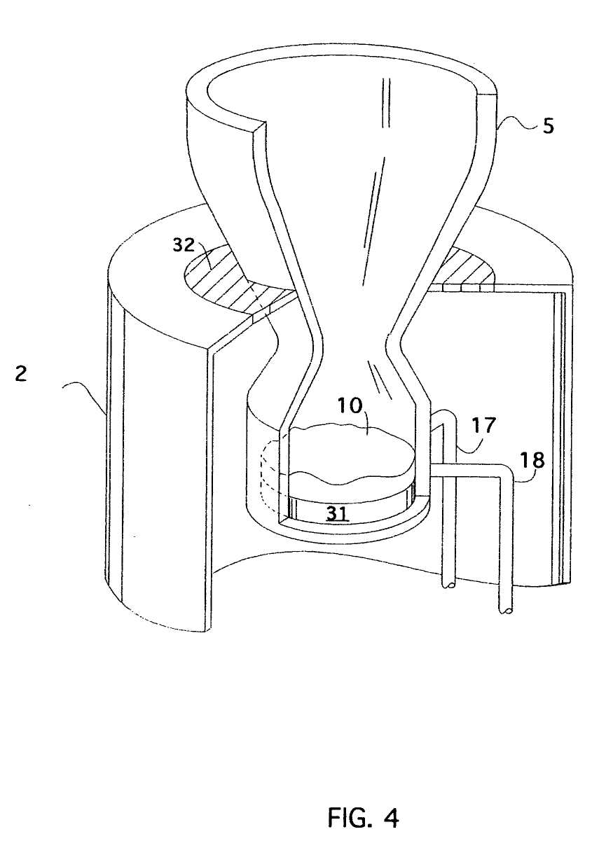

Referring to FIG. 4, an illustration of solidified first protectant material 10 protecting the rocket engine 5, forming a barrier to sea water from reaching the engine injector 30.

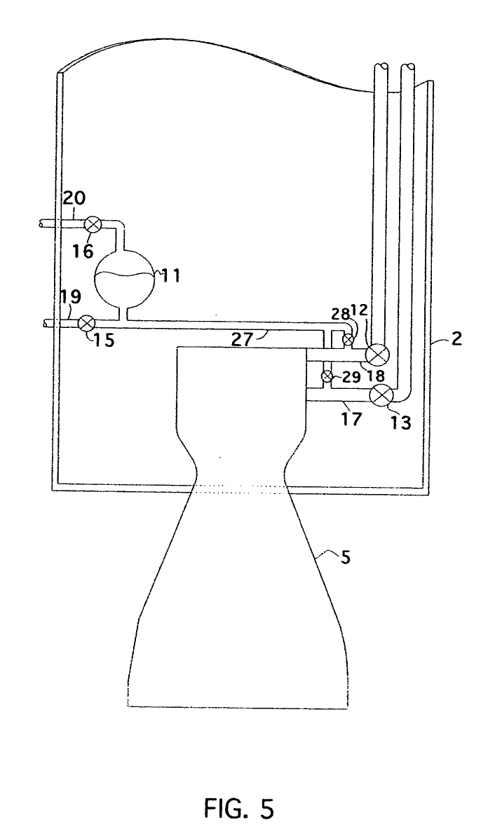

Referring to FIG. 5, an enlarged schematic drawing of the lower end of the rocket stage 2 is shown.

In the preferred embodiment, one would use a positive expulsion bladder within reservoir 11 to contain the gas so that first protectant material can be expelled from the reservoir at any orientation of the rocket. The system can be made such that the bladder can be loaded from an external source before launch. The first protectant material reservoir will then contain the first protectant material and enough pressured gas to expel it. Another variation to this design, would be to include a pump to the reservoir, or to use the pressurized gas from the propellant or oxidizer tank to expel the first protectant material from the reservoir.

Possible materials that the first protectant material could consist of include non-water soluble foam, grease, oil the like.

After the stage is recovered, a dissolvent is used to flush out the first protective material from the plumbing of the engine and the injector. The dissolvent should be able to cause the first protectant material return to a liquid or semi-liquid form without damaging the engine. Possible liquids that the dissolvent could consist of include alcohol or other solvents which dissolves first protectant material.

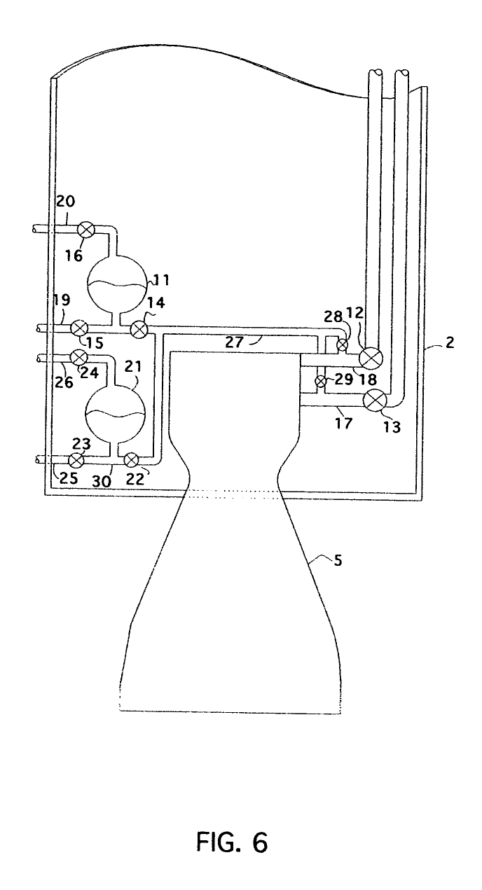

Referring to FIG. 6, the possibility of including a second reservoir 21 for an additional protective substance is shown. In addition to the parts already previously described, the first protective substance is stored in reservoir 21. It joins with inlet 30 to connect with tube 27 through valve 22. Inlet 30 also connects to valve 23 which is connected to inlet 25. A combination such as an oil followed by a foaming substance could be used to protect the injector.

The first protective substance must be able to adhere to the engine surface and prevent ocean water from reaching the surface. Possible compounds that this substance could consist of include oil, grease, gel, foam, or other such materials that will not be washed away by the water and prevent the water from reaching the surface of the engine.

Operational Description

Referring to FIG. 1, a sequential illustration of a typical launch of a two stage vehicle is shown. The lower stage 2 separates from the upper stage 3 and reenters the earth's atmosphere. The upper stage continues to space until it has reached its target or orbit. The lower stage slows to a speed compatible with a parachute. A parachute 6 is then deployed. The parachute is secured to the aft end of the rocket engine 5. This is to keep as much landing impact off of the engine as possible. After falling to earth, the main stage engine 2 lands in the ocean 7. The rocket floating in the water is illustrated in FIG. 2.

Upon return to earth, the main valves are closed and the first protectant material valves 28 and 29 are opened, and the first protectant material is caused to flow through tube 27 into the inlets 17 and 18 and engine by gas pressure on the positive expulsion bladder. The first protectant material will solidify throughout the engine into a solid material or foam as shown in FIG. 4.

Referring to FIG. 4, an illustration of solidified first protectant material 10 is shown protecting the rocket engine 5. After landing no substantial water damage to engine should occur because a liquid first protectant material will have spread into the thrust chamber and solidified while the rocket was falling to earth. In the preferred embodiment, a seal 32 connects the outside of the engine nozzle to the tail of the rocket, and prevent any water from reaching the area around the base of the engines.

The first protectant material reservoir is filled before launch by opening valve 15 and passing first protectant material into the inlet 19 while the valves 28 and 29 are closed. In the preferred embodiment, the first protectant material reservoir is pressurized by opening valve 16 and pressurizing the tank through inlet 20, to provide gas pressure to expel the first protectant material.

The removal of the first protectant material is accomplished once the rocket stage has been recovered. One method for this would be to open valves 15, 28, and 29 and pass a first protectant material dissolvent into inlet 19.

If a cryogenic propellant is used, the plumbing may need to warmed before the first protectant material is released. Cold plumbing may cause the first protectant material to become less vicious and thereby inhibiting it from reaching the engine. There may be other undesired chemical/mechanical effects on the first protectant material due to the cold plumbing. One method would be to allow heated pressurized gas to flow into the engine after all of the fuel has been burned and before the first protectant material is released. If the propellant tank was pressurized with heated gas, then valves 12 and 13 could simply be remained open to pass the hot gas through the pipes to warm the plumbing; otherwise, another gas heating system can be included that would be used to heat the plumbing.

This system of applying a protective material can be extended by more than one type of protectant material. The following describes the detailed operational description of material system, such as oil and foam.

Referring to FIG. 6, a diagram of a system is shown wherein two types of protectant materials are employed. Upon the rocket's return to earth, valve 22 is opened first, allowing the first protective substance to pass through tube 27 and then to the engine. The inner and exterior surface of the engine will become coated with the first protective substance. Once complete, the valve is closed and valve 14 is opened allowing the second protectant material to pass through the engine in the same manner as previously mentioned.

The second protective substance reservoir 21 is supplied by opening valve 23 and passing in the second protective substance through inlet 25 while valve 22 is closed. The second protective substance reservoir will also be pressurized prior to launch by opening valve 24 and pressurizing the reservoir through inlet 26.

The pressurized gas in the second protective substance reservoir, can be contained in a positive expulsion bladder, as in the same design as the first protectant material reservoir. The gas can also be pressurized the pressurized gas contained in the fuel tank 9 or oxidizer tank 8, or gas from a gas pressurization system for the propellant tanks.

A second protective substance dissolvent is applied by passing it through inlet 25 while valves 22, 28 and 29 are open. This would be done after the first protectant material dissolvent is applied. Dissolvents are used to remove all traces of the protectant materials prior to the engine being fired again.

While the invention has been described in the specification and illustrated in the drawings with reference to a main embodiment and certain variations, it will be understood that these embodiments are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

1. A system for protecting a rocket engine, comprising:
a storage reservoir of first protectant material;
a conduit to deliver first protectant material to the engine injector;
a valve to isolate first protectant material storage reservoir;
an apparatus configured to drive the first protectant material from the reservoir to the engine injector;
a control system configured to cause after the engine has finished firing but before the rocket engine lands in the ocean.

2. The system as defined in claim 1, wherein the first protectant material is comprised of a viscous-liquid material.

3. The system as defined in claim 1, wherein the first protectant material after application expands into a solid foam.

4. The system as defined in claim 1, wherein the first protectant material is a light oil.

5. The system as defined in claim 1, wherein the rocket engine is mounted at a fixed orientation relative to the vehicle.

6. The system as defined in claim 1, further comprising a mechanism for releasing warming gas to warm after the engine after engine shutdown to a temperature the first protectant material can flow.

7. The system in claim 6, wherein the pressurant gas in one of the propellant tanks is used for a gas supply to warm the engine.

8. The system in claim 6, wherein the pressurant gas system for the tanks supplies the gas to warm the engine.

9. The system as defined in claim 1 wherein the first protectant material shall be stored in a positive expulsion bladder within the reservoir.

10. The system as defined in claim 10, wherein the first protectant material shall be forced out of the reservoir with gas after the engine has shut down and before the stage lands in the ocean.

11. The system as defined in claim 10, wherein the first protectant material shall be forced out of the reservoir with gas from the main propellant tank gas pressurization system.

12. The system as defined in claim 10, wherein the first protectant material shall be forced out of the reservoir with gas remaining in one of the propellant tanks of the vehicle.

13. The system as defined in claim 1, wherein the rocket engine is pressure fed.

14. A system for protecting a rocket engine, comprising:
a first storage reservoir of first protectant material;
a second storage reservoir of second protectant material;
a conduit to deliver first protectant material to the engine injector;
a conduit to deliver second protectant material to the engine injector;
a valve to isolate first protectant material storage reservoir;
a valve to isolate second protectant material storage reservoir;
an apparatus configured to drive the first protectant material from the reservoir to the engine injector;
an apparatus configured to drive the second protectant material from the reservoir to the engine injector;
a control system configured to release the first protectant material, then release the second protectant material after the engine has finished firing.

15. The system as defined in claim 14, wherein the first protectant material is comprised of a light oil.

16. The system as defined in claim 14, wherein the second protectant material after application expands into a solid foam.

17. The system as defined in claim 14, wherein the second protectant material is a viscous grease.

18. The system as defined in claim 14, wherein the first protectant materials shall be forced out of the reservoir with gas after the engine has shut down, then the second protectant material shall be forced out into the injector, before the stage lands in the ocean

19. A method for protecting a rocket engine during ocean recover, the method comprising injecting a water barrier protectant material into the rocket engine injector physically block the injector from contacting ocean water, the material being injected before the rocket lands in the ocean but after it has finished its burn.
